(19) United States
(12) Patent Application Publication
(10) Pub. No.: US 2016/0177242 A1
(43) Pub. Date: Jun. 23, 2016

(54) System and Method for Making a Popsicle Including a Liquid Container

(71) Applicants: Robert C. McDaniels, Staten Island, NY (US); Ross Macey, Brooklyn, NY (US)

(72) Inventors: Robert C. McDaniels, Staten Island, NY (US); Ross Macey, Brooklyn, NY (US)

(21) Appl. No.: 14/576,305

(22) Filed: Dec. 19, 2014

(51) Int. Cl. C12G 3/06; A23L 3/36

(52) U.S. Cl. CPC C12G 3/06; A23L 3/36

(57) ABSTRACT

A method for making a Popsicle embedded with a liquid container is disclosed. The method for making a popsicle with a liquid container comprises: filling a plurality of liquid containers with liquor; sealing a plurality of top portions on the plurality of liquid containers; placing the plurality of the top portion of the plurality of liquid containers upside down on a plurality of stoppers disposed in a bottom portion of a popsicle tray mold; compressing and interlocking a top portion of the popsicle tray mold over the bottom portion of the popsicle tray mold; filling the bottom portion of the popsicle tray mold with a flavored liquid; flash freezing the pop side tray mold; and forming a plurality of popsicles embedded with the plurality of liquid containers.

### FIELD OF THE INVENTION

The present invention relates to a system and method of making a Popsicle including a liquid container.

### BACKGROUND OF THE INVENTION

Generally, ice cream and other types of frozen desserts such as Popsicles® have been enjoyed by people all over the world for a long time. Popsicles were invented back in the 1920's and since then there's been many variations on the original Popsicles including name brand treats such as the Fudgesicle®, Creamsicle® etc. Also, because of advances in manufacturing technology and food science there have been multi-colored, multi-flavored, multi-textured, low fat, low calorie and other types of Popsicles.

In order to enhance the experience of enjoying a Popsicle, some individuals may desire a refreshing alcoholic beverage with their Popsicle that doesn't conflict with a regular flavored Popsicle, but this type of Popsicle hasn't been developed. Thus, there is a need for a Popsicle that includes the refreshing alcoholic beverage that doesn't conflict with the regular flavored Popsicle.

### SUMMARY OF THE INVENTION

The present invention has been accomplished in view of the above-mentioned technical background, and it is an object of the present invention to provide a method and system of making popsicles including a liquid container.

A method for making a Popsicle embedded with a liquid container is disclosed. The method for making a popsicle with a liquid container comprises: filling a plurality of liquid containers with liquor; sealing a plurality of top portions on the plurality of liquid containers; placing the plurality of the top portion of the plurality of liquid containers upside down on a plurality of stoppers disposed in a bottom portion of a popsicle tray mold; compressing and interlocking a top portion of the popsicle tray mold over the bottom portion of the popsicle tray mold; filling the bottom portion of the popsicle tray mold with a flavored liquid; flash freezing the pop side tray mold; and forming a plurality of popsicles embedded with the plurality of liquid containers.

In yet another embodiment of the invention, a system for embedding a plurality of Popsicles with a plurality of shot pops. The system comprises a plurality of shot pops are filled with liquor. A plurality of head portions of the plurality of shot pops are sealed. The plurality of liquid containers are configured to be placed upside down into a Popsicle tray mold, wherein the plurality of head portions are placed on a plurality of stoppers disposed in a bottom portion of the Popsicle tray mold. A top portion of the Popsicle tray mold is fastened on top of the bottom portion of the Popsicle tray mold, wherein the plurality of shot pops are prevented from moving in the bottom portion of the Popsicle tray mold. The bottom portion of the Popsicle tray mold is filled with a flavored liquid. The Popsicle tray mold is placed in a flash frozen device, where the flavored liquid is frozen to become a plurality of Popsicles around the plurality of shot pops. The Popsicle tray mold is removed from the flash frozen device so the plurality of Popsicles around the plurality of shot pops can be removed from the bottom portion of the Popsicle tray mold.

### BRIEF DESCRIPTION OF THE DRAWINGS

These and other advantages of the present invention will become more apparent as the following description is read in conjunction with the accompanying drawings, wherein:

FIGS. 1A and 1B show a top portion of a Popsicle mold and a bottom portion of a Popsicle mold in accordance invention;

FIG. 1C is a top view of the top portion of a Popsicle mold affixed to the bottom portion of the Popsicle mold in accordance with the invention;

FIG. 1D is an upward view of the top portion of the Popsicle mold of FIG. 1A in and a bottom portion of the Popsicle mold of FIG. 1A in accordance with the invention;

FIG. 1E is a view of the bottom portion of the Popsicle mold in accordance with the invention;

FIG. 1F is a top view of the top portion of the Popsicle mold tightly clamped down onto the bottom portion of the Popsicle mold in accordance with the invention;

FIG. 2 is a view of a plurality of shot pops in accordance with the invention;

FIG. 3 shows a flow-chart of how Popsicles are made in accordance with the invention; and

FIG. 4 is a view of plurality of Popsicles embedded with a plurality of shot pops in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

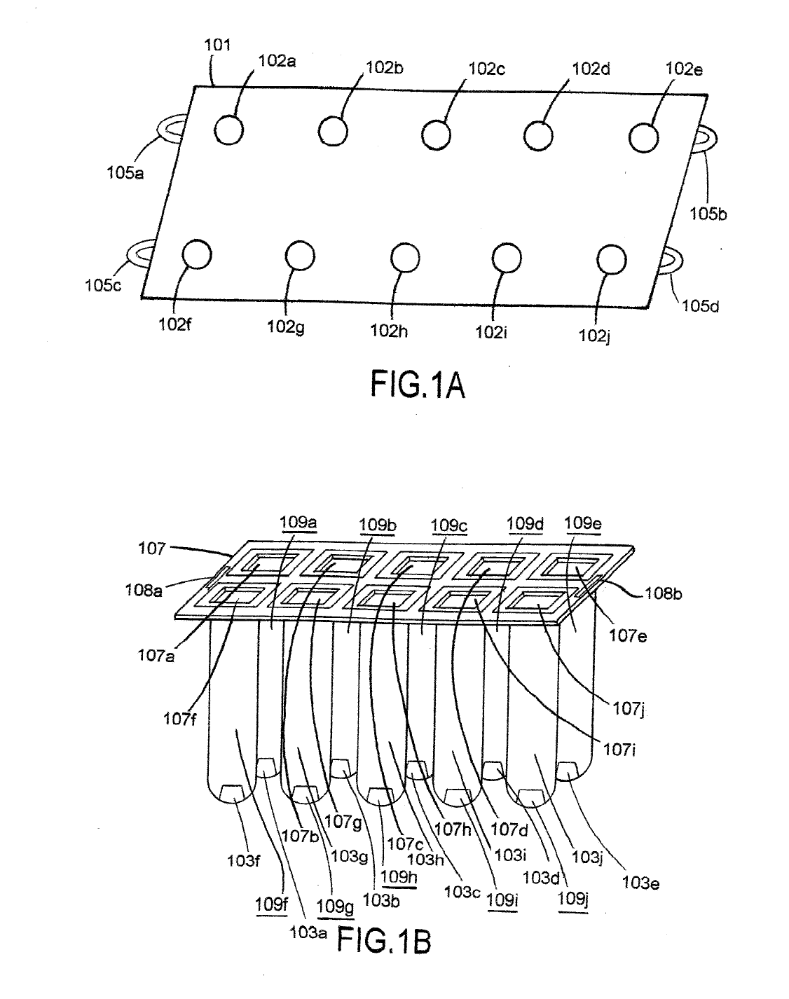

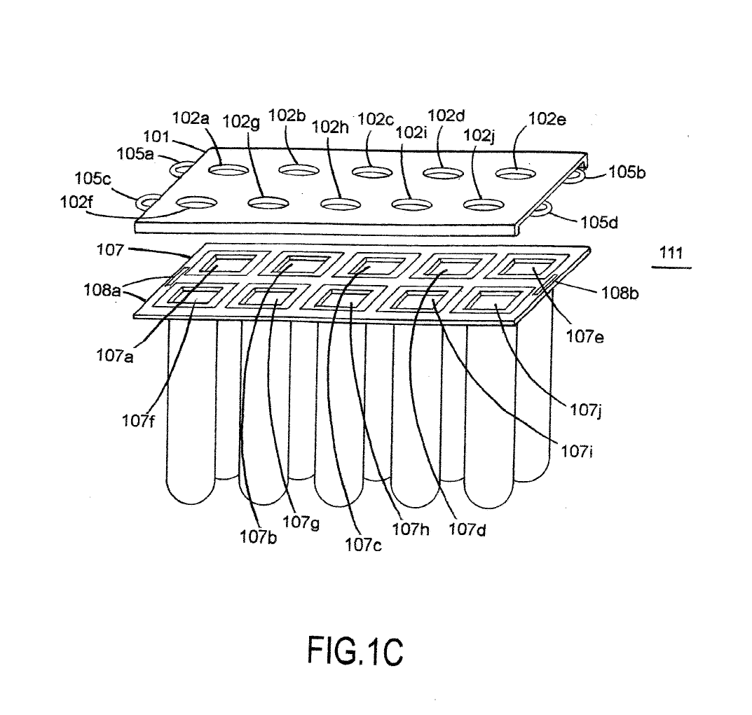

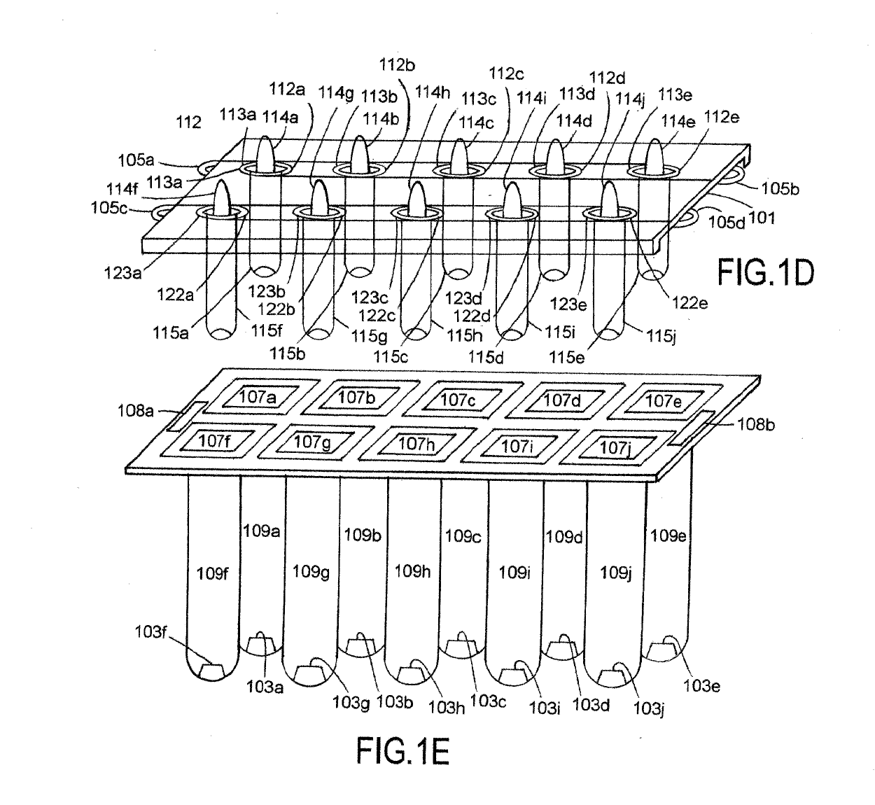

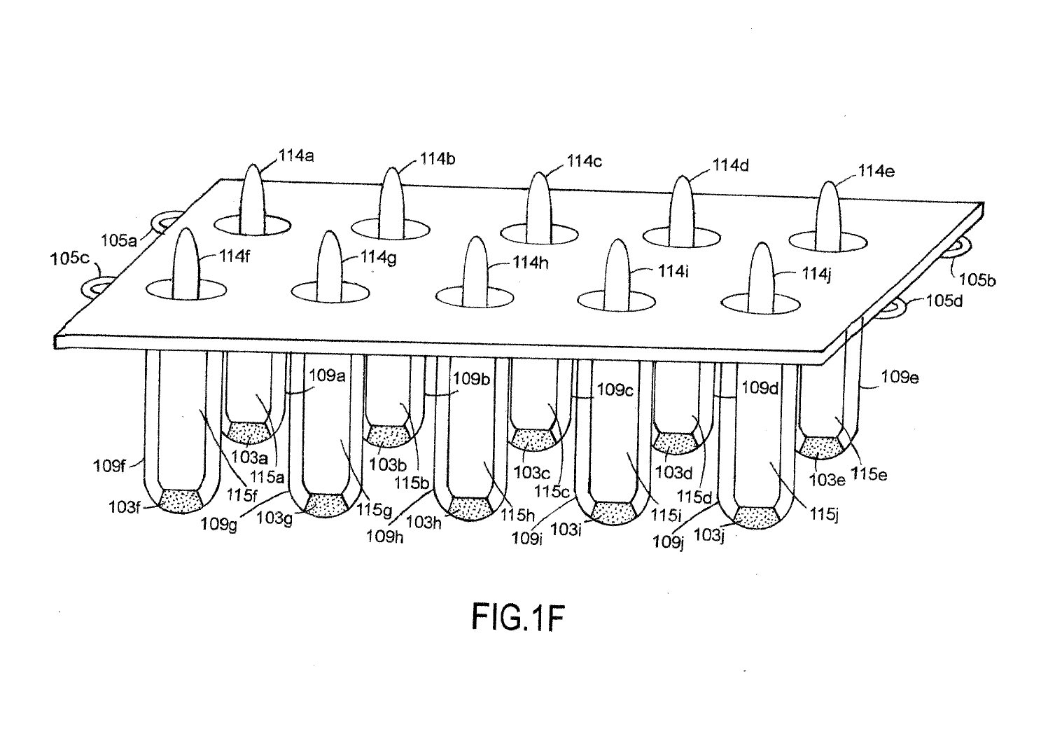

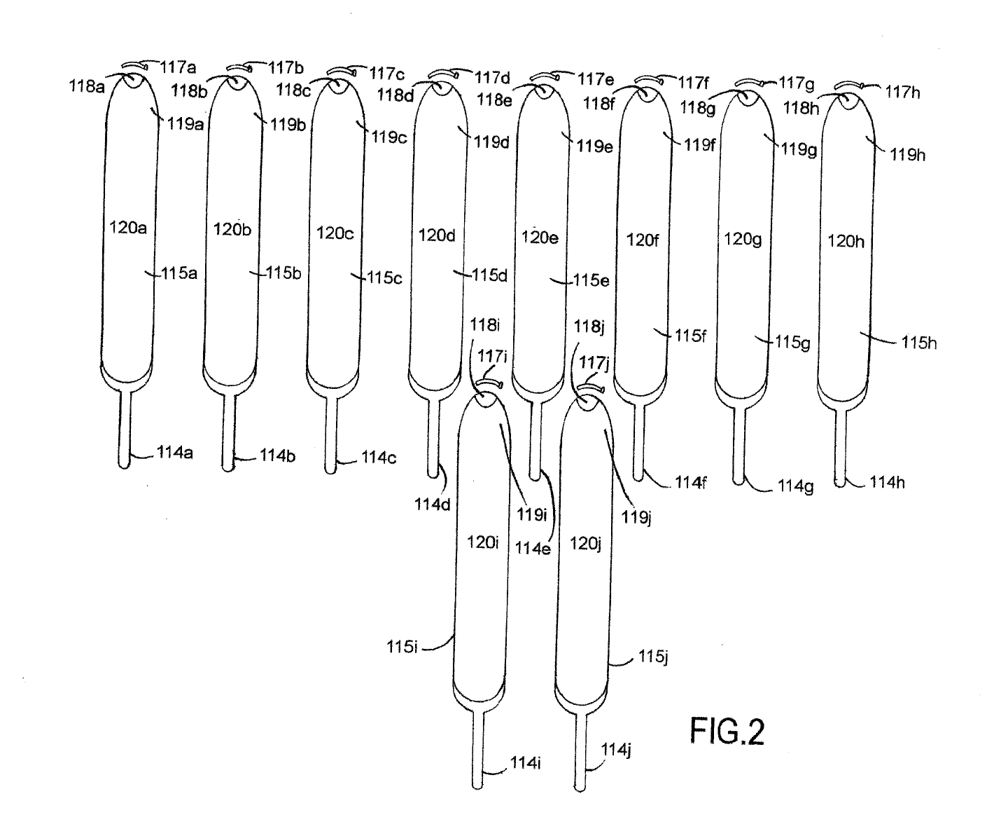

FIGS. 1A and 1B show a top portion of a Popsicle tray mold and a bottom portion of the Popsicle tray mold in accordance with the invention. FIG. 1A shows a top portion 101 of a typical Popsicle tray mold. Top portion 101 includes slot 102a, slot 102b, slot 102c, slot 102d, slot 102e, slot 102f, slot 102g, slot 102h, slot 102i and slot 102j (slots 102 a-j). The top portion 101 is made of stainless steel and has length in the range of 6 inches to 1 foot or more, preferably 9 inches and has a width in the range of 4 to 10 inches, preferably 4 inches. Top portion 101 has a thickness in a range of ¼ inch to ¾ inch, preferably ½ inch. Each of the slots 102a-j have an opening where a plurality of stems 114a, 114b, 114c, 114d, 114e, 114f, 114g, 114h, 114i and 114j of a plurality of shot pops 115a-j (FIG. 2) can protrude out from it. Also, top portion 101 includes locking clips 105a, 105b, 105c and 105d on the left and right side of the top portion 101 in order to prevent the movement of the plurality of shot pops 115 a-j (FIG. 1F).

At FIG. 1B, a bottom portion 107 of the popsicle tray mold includes slot 107a, slot 107b, slot 107c, slot 107d, slot 107e, slot 107f, slot 107g, slot 107h, 107i and slot 107j are respectively on top of a plurality of bottom compartments 109a, 109b, 109c, 109d, 109e, 109f, 109g, 109h, 109i and 109j. The bottom portion 107 is made of stainless steel and has a length in the range of 6 inches to 1 foot or more, preferably 9 inches and has a width in the range of 4 to 10 inches, preferably 4 inches. Bottom portion 107 has a thickness in a range of ¼ inch to ¾ inch, preferably ½ inch. FIG. 1C shows the top portion 101 on top of the bottom portion 107 to form the Popsicle tray mold 111. The top portion 101 of slot 102a, slot 102b, slot 102c, slot 102d, slot 102e, slot 102f, slot 102g, slot 102h, slot 102i and slot 102j fits or is respectively disposed over a top of the bottom portion 107 of the popsicle tray mold 111 on slot 107a, slot 107b, slot 107c, slot 107d, slot 107e, slot 107f, slot 107h, 107i and slot 107j. Top portion 101 with locking clips 105a, 105b, 105cand 105d clamps down on respective clip receptors 108a and 108b to tightly hold the top portion 101 of Popsicle tray mold 111 onto the bottom portion 107. The popsicle tray mold 111 may have any type of shape, such as a pear, shape of a bat, shape of animated figure or any type of figure.

FIG. 1D shows a view of the bottom of the top portion of the Popsicle mold of FIG. 1A. Top portion 101 has the locking clip 105a that pulls an elongated metal rod 112 east, where the metal rod 112 has flat curvature hooks 112a, 112b, 112c, 112d, 112e. Curvature hooks 112a-e may be referred to as locking arms. The elongated metal rode 112 has a length in the range of 6 to 12 inches and the curvature hooks 112a-e has a length in the range of ½ inch to 1 inch. The locking clip 105a with the metal rod 112 pulls the curvature hooks 112a, 112b, 112c, 112d and 112e east as they are placed around the underside of respective slots 102a, 102b, 102c, 102 and 102e, which works with the locking clip 105b to hold the respective stems 114a-e. The locking clip 105b pulls an elongated metal rod 113 west, where the metal rod 113 has flat curvature hooks 113a, 113b, 113c, 113d and 113e that pulls the respective stems 114a-e west. Curvature hooks 113a-e may be referred to as locking arms. The elongated metal rod 113 has a length in the range of 6 to 12 inches and the curvature hooks 113a-e has a length in the range of ½ inch to 1 inch. The eastward pull of the locking clip 105a with the metal rod 112 onto the respective stems 114a-e and the westward pull of the locking clip 105b with the metal rod 113 onto the respective stems 114a-e keeps the stems 114a-e tightly in place and locks the stems 114a-e in place in the bottom portion 107 of the popsicle tray mold 111. (FIG. 1E)

Top portion 101 has the locking clip 105c that pulls an elongated metal rod 122 east, where the metal rod 122 has flat curvature hooks 122a, 122b, 122c, 122d and 122e. Curvature hooks 122a-e may be referred to as locking arms. The elongated metal rode 122 has a length in the range of 6 to 12 inches and the curvature hooks 122a-e has a length in the range of ½ inch to 1 inch. The locking clip 105c with the metal rod 122 pulls the curvature hooks 122a, 122b, 122c, 122d and 122e east as they are placed around the underside of respective slots 102f, 102g, 102h, 102i and 102j that works with the locking clip 105d to hold the respective stems 114f-j in place. The locking clip 105d pulls an elongated metal rod 123 west, where the metal rod 123 that has flat curvature hooks 123a, 123b, 123c, 123d and 123e pulls the respective stems 114f-j west. Curvature hooks 123a-e may be referred to as locking arms. The elongated metal rode 123 has a length in the range of 6 to 12 inches and the curvature hooks 123a-e has a length in the range of ½ inch to 1 inch. The eastward pull of the locking clip 105c with the metal rod 122 onto the respective stems 11f-j and the westward pull of the locking clip 105d with the metal rod 123 onto the respective stems 114f-j keeps the stems 114f-j tightly in place and locks them in place in the bottom portion 107 of the Popsicle tray mold 111. (FIG. 1E)

FIG. 1F shows the top portion fully covering the bottom portion of the Popsicle tray mold. The respective lock clips 105a and 105b secures the stems 114a-e of the respective plurality of shot pops 115a-e within the bottom portion 107 of popsicle tray mold 111 while respective locks 105c and 105d secures the stems 114f-j of the respective plurality of shot pops 115f-j in the bottom portion of 107 of the popsicle tray mold 111. Stems 114a-j are tightly held by the lock clips 105a, lock clip 105b, metal rod 112, metal rod 113, lock clip 105c, lock clip 105d, metal rod 122 and metal rod 123 in the bottom portion 107 of the popsicle tray mold 111 to prevent the stems 114 a-j from moving within the bottom portion 107.

FIG. 2 shows liquid containers in accordance with the invention. The liquid containers 115a, 115b, 115c, 115d, 115e, 115f, 115g, 115h, 115i and 115j are referred to as a plurality of shot pops 115a-j. The liquid containers 115a-j are also known as shot pops, which are liquid containers that are made of a food grade plastic designed to hold and keep liquor cold while popsicles are formed around the liquid containers. The plurality of shot-pops 115a-j are liquid containers that include: a plurality of hollow bodies 120a, 120b, 120c, 120d, 120e, 120f, 120g, 120h, 120i and 120j; a plurality of tear away openings 118a, 118b, 118c, 118d, 118e, 118f, 118g, 118h, 118i and 118j; a plurality of head portions 119a, 119b, 119c, 119d, 119e, 119f, 119g, 119h, 119i and 119j; and a plurality of stems 114a, 114b, 114c, 114d, 114e, 114f, 114g, 114h, 114i and 114j. A plurality of sealing tabs 117a, 117b, 117c, 117d, 117e, 117f, 117g, 117h and 117i are disposed over respective tear away openings 118a-j of the plurality of shot pops 115a-j in order to seal these tear away openings 118a-j.

The plurality of hollow bodies 120a, 120b, 120c, 120d, 120e, 120f, 120g, 120h, 120i and 120j are made of food grade plastic and have a body height in the range of 2 to 4 inches, preferably 3½ inches and a diameter in a range of 1.5 to 3 inches, preferably 2.5 inches wide. These plurality of hollow bodies 120a-j can hold anywhere between 1-1.25 ounces of liquor, such as brandy, whisky, vodka, scotch or any kind of spirited liquor. The plurality of sealing tabs 117 are separate peel away tabs, which may be aluminum foil tabs that can be placed on top of the plurality of tear away openings 118a-j.

The plurality of tear away openings 118a-j have a width in the range of ¼ inch to ½ inch, preferably ¼ inch. The plurality of stems 114a-j have a length of 1.5 to 3 inches, preferably 2¼ inches and may be made of plastic. The total size of the plurality of shot pops 115a-j are in the range of about 3.5 inches to 7 inches, preferably 5¼ inches. The plurality of tear away openings 118a-j, which may be surrounded by a glue like substance, is where the liquor may be poured into the plurality of head portions 119a-j of the plurality of shot-pops 115a-j then the plurality of sealing tabs 117a-j seals these tear away openings 118a-j to prevent the liquor from leaking out of the plurality of shot pops 115a-j.

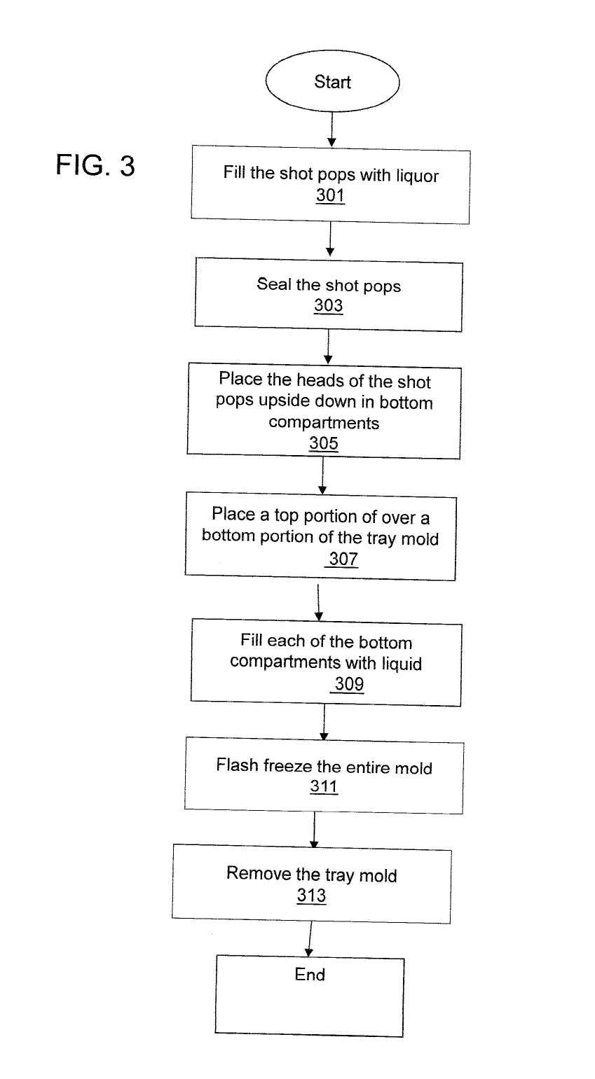

FIG. 3. shows a flow-chart of how popsicles are made and embedded with shot pops in accordance with the invention. At block 301, the hollow bodies 120a-j of the plurality of shot pops 115a-j (FIG. 2) are filled with about 1 to 1.25 ounces of liquor, such as brandy, scotch, whisky, vodka or any type of spirits liquor. Next, at block 303 the plurality of shot pops 115 a-j are sealed at a top portion or at a plurality of heads 119a-j of the shot pops 115 where the plurality of sealing tabs 117 are sealed/glued on to the respective openings 118a-j. For example, the plurality of shot pops 115 a-j are sealed by pressing the sealing tabs 117a-j onto the tear away openings 118a-j, which have a food grade plastic glue, onto the plurality of heads 119a-j of the plurality of shot pops 115a-j.

At block 305, the plurality of shot pops 115a-j are placed upside down into the popsicle tray mold 111 where the plurality of heads 119a-j of the plurality of shot pops 115a-j sit on top of the plurality of stoppers 103a, 103b, 103c, 103d, 103e, 103f, 103g, 103h, 103i and 103j in the bottom portion 107 of the plurality of bottom compartments 109a, 109b, 109c, 109d, 109e, 109f, 109g, 109h, 109i and 109j (109a-j) that makes the plurality of stems 114a, 114b, 114c, 114d, 114e, 114f, 114g, 114h, 114i and 114j (114a-j) stick out from the top portion 101. Bottom portion 107 and the top portion 101 of the Popsicle tray mold 111 are made of stainless steel. The plurality of stoppers 103a, 103b, 103c, 103d, 103e, 103f, 103g, 103h, 103i and 103j are disposed inside the plurality of bottom compartments 109a, 109b, 109c, 109d, 109e, 109f, 109g, 109h, 109i and 109j. (FIG. 1F)

The plurality of stoppers 103a-j are made of stainless steel, where the plurality of stoppers 103a-j are able to prevent any liquid from leaking from the plurality of heads 119a-j of the plurality of shot pops 115a-j into the plurality of bottom compartments 109a-j. Next, at block 307 the top portion 101 of the Popsicle tray mold 111 is placed on top of the bottom portion 107 so that the plurality of stems 114a-j sticks through the top portion 101. The locking clips 105a, 105b, 105c and 105d are simultaneously pressed down to lock the top portion 101 onto the bottom portion 107. Top portion 101 has the locking clip 105a that is pressed down so that the elongated metal rod 112 is pulled east, where the metal rod 112 has flat curvature hooks 112a, 112b, 112c, 112d, 112e. The locking clip 105a with the metal rod 112 pulls the curvature hooks 112a, 112b, 112c, 112d and 112e east as they are placed around the underside of respective slots 102a, 102b, 102c, 102 and 102e that works with the locking clip 105b to hold the respective stems 114a-e. The locking clip 105b is pressed down which pulls an elongated metal rod 113 west, where the metal rod 113 has flat curvature hooks 113a, 113b, 113c, 113d and 113e that pulls the respective stems 114a-e west. The eastward pull of the locking clip 105a with the metal rod 112 onto the respective stems 114a-e and the westward pull of the locking clip 105b with the metal rod 103 onto the respective stems 114a-e keeps the stems 114a-e tightly in place in the bottom portion 107 of the popsicle tray mold 111 (FIG. 1F).

Top portion 101 has the locking clip 105c which is pressed down pulls an elongated metal rod 122 east, where the metal rod 122 has flat curvature hooks 122a, 122b, 122c, 122d and 122e. The locking clip 105c with the metal rod 112 pulls the curvature hooks 122a, 122b, 122c, 122d and 122e east as they are placed around the underside of respective slots 102f, 102g, 102h, 102i and 102j that works with the locking clip 105d to hold the respective stems 11f-j. The locking clip 105d, which is pressed down pulls an elongated metal rod 123 west, where the metal rod 123 has flat curvature hooks 123a, 123b, 123c, 123d and 123e pulls the respective stems 114f-j west. The eastward pull of the locking clip 105c with the metal rod 122 onto the respective stems 114f-j and the westward pull of the locking clip 105d with the metal rod 123 onto the respective stems 114f-j keeps the stems 114f-j tightly in place in the bottom portion 107 of the popsicle tray mold 111 (FIG. 1F).

The top portion 101 is compressed onto the bottom portion 107 so that the locking clips 105a and 105c respectively interlocks with lock receptor 108a while the locking clips 105b and 105c respectively interlock with lock receptor 108b that holds the stems 114a-j in place while the top portion 101 is compressed onto the bottom portion 107 to form the popsicle tray mold 111. The compression of the top portion 101 onto the bottom portion 107 prevents the plurality of shot pops 115a-j from moving in the plurality of bottom compartments 109a-j and also puts pressure on the plurality of shot pops 115a-j forming a seal around the plurality of heads 119a-j of the plurality of shot pops 115a-j.

Next, at block 309, each of the plurality of bottom compartments 110a-j of the bottom portion 107 of the Popsicle tray mold 111 is filled with a flavored liquid to complement the liquor in the plurality of shot pops 115a-j. The flavored liquid may be any type of flavored liquid or concentrate, for example, cherry, lime, pineapple, pina colada, coconut, strawberry, watermelon or any combination thereof or any desirable non-alcoholic liquid. Also, the flavored liquid may be soda, water, orange juice or a malt beverage.

Next, at block 311, the popsicle tray mold 111 is flash frozen by freezing the popsicle tray mold 111 in any type of flash freezing device, such as a bath of clear gel that freezes at approximately minus 15 to minus 25 degrees Celsius, preferably minus 20 degrees Celsius where the flavored liquid surrounding the plurality of shot pops 115a-j freezes but the liquor in the plurality of shot pops 115a-j does not freeze. This flash frozen device may be a large tub that has a holder where the Popsicle tray mold 111 sits on top where the liquid rises above it and then the Popsicle tray mold 111 goes through the flash frozen process for approximately 10-60 seconds, preferably 30 seconds. After the Popsicle tray mold 111 is inserted into the flash freeze device, then the flavored liquid formed around the plurality of shot pops 115a-j hardens and solidifies to form typical Popsicles embedded with the plurality of shot pops 115a-j.

Next, at block 313 the popsicle tray mold 111 is removed then put in a warm bath for anywhere between 10 to 30 seconds, preferably 15 seconds that loosens up the Popsicles and the plurality of the shot pops 115a-j form the bottom portion 107 of the bottom compartments 109a-j so that the plurality of shot pops 115a-j are not frozen against the stainless steel bottom compartments 109a-j so you can pull them and stick them in a bag in freezer for transport or sales, then this process ends.

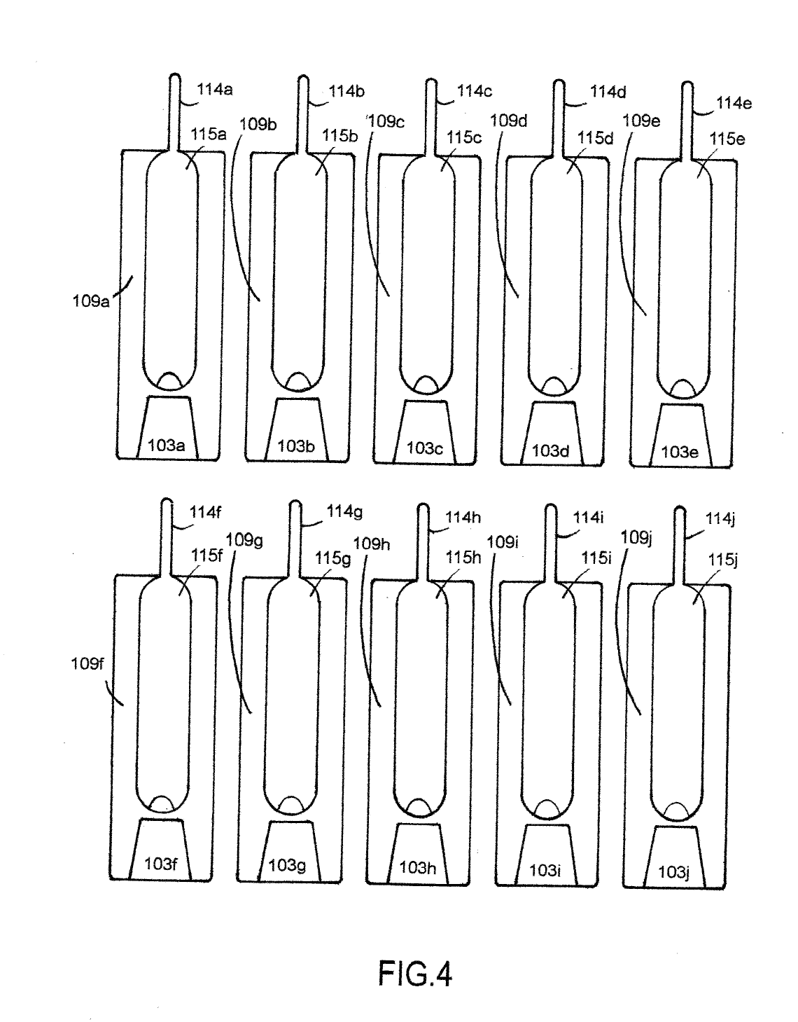

FIG. 4 shows views of individual plurality of shot pops upside down disposed on a plurality of stoppers in a plurality of bottom compartments in accordance with the invention. Each of the plurality of shot pops 115a-j are disposed on the plurality of stoppers 103a-j, whereby the plurality of stoppers 103a-j prevents any liquid from leaking from the opening 118a-j into the plurality of bottom compartments 109a-j. A flavored liquid, described above, such as cherry, pina colada etc. is poured into the plurality of bottom compartments 109a-j filling up the plurality of bottom compartments 109a-j so the steel stoppers 103a-j prevents this flavored liquid from going into the plurality of shot pops 115a-j and prevents the alcohol from the plurality of shot pops 115a-j from leaking into the plurality of bottom compartments 109a-j. The plurality of steel stoppers 103a-j may be made of stainless steel that is able to receive the plurality of shot pops 115a-j container and hold it in place without any liquid from the plurality of shot pops 115a-j from dispersing into the plurality of bottom compartments 109a-j. The plurality of steel stoppers 103a-j has a size of ¼ inch to ½ inch length and a width of ¼ inch.

This invention provides a simple system and method for making a Popsicle including a liquid container. A person is able to utilize this invention to create a solid Popsicle including a liquid container for alcohol, where this invention keeps the liquid container for alcohol cold and prevents the alcohol from the liquid container from mixing with the solid Popsicle. Further, the person can easily access alcohol from the liquid container by allowing the person to pull off a peel away tab on the liquid container.

Although the present invention has been described above in terms of specific embodiments, many modifications and variations of this invention can be made as will be obvious to those of ordinary skill in the art, without departing from its spirit and scope as set forth in the following claims.

What is claimed is:

1. A method for making a popsicle with a liquid container, the method comprising:
filling a plurality of liquid containers with liquor;
sealing a plurality of top portions on the plurality of liquid containers;
placing the plurality of the top portion of the plurality of liquid containers upside down on a plurality of stoppers disposed in a bottom portion of a popsicle tray mold;
compressing and interlocking a top portion of the popsicle tray mold over the bottom portion of the popsicle tray mold;
filling the bottom portion of the popsicle tray mold with a flavored liquid;
flash freezing the popsicle tray mold; and
forming a plurality of popsicles embedded with the plurality of liquid containers.

2. The method of claim 1, wherein the liquor in the plurality of liquid containers is from the group comprising brandy, scotch, whisky or vodka.

3. The method of claim 1, wherein sealing the plurality of top portions further comprises sealing a sealing plurality of tabs onto a plurality of openings of the plurality of liquid containers.

4. The method of claim 1, wherein the flavored liquid is from the group comprising orange juice, cherry, pina colada and strawberry.

5. The method of claim 1, wherein the popsicle tray mold is flash frozen device for the period of time in the range of 5-30 seconds.

6. The method of claim 1, wherein the plurality of liquid containers are a plurality of food grade containers.

7. The method of claim 1, wherein the plurality of liquid containers are a plurality of shot pops.

8. A system for making a plurality of popsicles embedded with a plurality of shot pops, the system comprising:
a plurality of shot pops are filled with liquor;
a plurality of head portions of the plurality of shot pops are sealed;
the plurality of liquid containers are configured to be placed upside down into a popsicle tray mold, wherein the plurality of head portions are placed on a plurality of stoppers disposed in a bottom portion of the popsicle tray mold;
a top portion of the popsicle tray mold is fastened on top of the bottom portion of the popsicle tray mold, wherein the plurality of shot pops are prevented from moving in the bottom portion of the popsicle tray mold;
the bottom portion of the popsicle tray mold is filled with a flavored liquid;
the popsicle tray mold is placed in a flash frozen device, wherein the flavored liquid is frozen to become a plurality of Popsicles around the plurality of shot pops; and
the popsicle tray mold is removed from the flash frozen device so the plurality of Popsicles around the plurality of shot pops can be removed from the bottom portion of the popsicle tray mold.

9. The system of claim 8, wherein the plurality of stoppers are made of stainless steel.

10. The system of claim 9, wherein the popsicle tray mold is placed in a flash frozen device for 30 seconds.
